(19) United States
(12) Patent Application Publication
(10) Pub. No.: US 2008/0016863 A1
(43) Pub. Date: Jan. 24, 2008

(54) Wave energy power generating apparatus

(75) Inventors: Chun-I Tai, Kaohsiung (TW); Wen-Chung Huang, Kaohsiung (TW)

Correspondence Address: BIRCH STEWART KOLASCH & BIRCH, PO BOX 747, FALLS CHURCH, VA, 22040-0747, US

(73) Assignees: Chun-I TAI; Wen-Chung HUANG; Joanna Chiung Lee HUANG

(21) Appl. No.: 11/491,144

(22) Filed: Jul. 24, 2006

(51) Int. Cl. F03B 17/02; F03B 13/18

(52) U.S. Cl. 60/497; 60/495

(57) ABSTRACT

A wave energy power generating apparatus includes a fixed base, a buoyant float unit and at least one gearing mechanism. The fixed base has a slide shaft mounted thereon for connecting with the buoyant float unit. The buoyant float unit includes a buoyant float slidably connected with the slide shaft, and at least one rack mechanism formed with a pair of rack members. The gearing mechanism includes a transmission shaft, and a pair of one-way gears connected with the transmission shaft and engaged with the rack members. The rack members can drive the one-way gears to rotate the transmission shaft in a single predetermined direction when an upward or downward movement of the buoyant float unit occurs.

### BACKGROUND OF THE INVENTION

1. Field of the Invention

The present invention relates to a wave energy power generating apparatus. Particularly, the present invention relates to the wave energy power generating apparatus having a buoyant float unit formed with at least one rack mechanism and at least one transmission shaft. More particularly, the present invention relates to the buoyant float unit of the wave energy power generating apparatus actuating the transmission shaft via the rack mechanism.

2. Description of the Related Art

A conventional power generating apparatus for use in the wave energy generation of power, as described in Taiwanese Patent Publication No. 547434, entitled “WAVE ENERGY BOAT”, is installed on a boat body, and includes a buoyant float unit and a gearing mechanism. Provided on the buoyant float unit are a rack member and a plurality of slide shafts. The rack member is engaged with the gearing mechanism. Each of the slide shafts is slidably received in a sleeve member such that the slide shafts can guide an upward or downward movement of the buoyant float unit.

The gearing mechanism includes a plurality of driving gears, a plurality of driven gears and a transmission shaft. Once assembled, the driving gears and the driven gears are mechanically engaged with each other. Furthermore, the driving gears are mechanically engaged with the rack member of the buoyant float unit so that an upward or downward movement of the buoyant float unit can rotate the transmission shaft in the same direction. When the boat body is disposed in water, waves of water can cause a certain extent of vertical reciprocation of the buoyant float unit for operating the power generating apparatus.

In operation, any upward or downward movement of the buoyant float unit can cause a rotational movement of the transmission shaft via the gearing mechanism so that wave energy is converted into mechanical energy. In this case, the transmission shaft may further mechanically connect with a power generator and a battery device. Accordingly, mechanical energy is converted into electric energy and stored in the battery device.

Generally, a number of design limitations exist for this conventional power generating apparatus due to its complicated structure in manufacturing and problematic aspects which naturally occur during use. With regard to the manufacture of such a complicated structure of the gearing mechanism, the arrangement of the driving and driven gears is complicated and subject to limitations in assembly and maintenance.

Another problem with the operation of the buoyant float unit is due to the fact that four of the slide shafts are arranged at four corners of the buoyant float unit. In reciprocating operation, there are inconsistent movements among the four slide shafts that may affect the movement of the buoyant float unit. Disadvantageously, the slide shafts and the sleeve members thereof are susceptible to distortion and loss in function after long-term use.

Another problem with the operation of the power generating apparatus is due to the fact that the entire apparatus is installed on the boat body. Accordingly, the boat body and the buoyant float unit are moved synchronously in the same direction that may cause loss of efficiency of the movement of the buoyant float unit. In other words, there is a limitation existing for the distance of the movement of the buoyant float unit. In addition to this, electricity generated from the power generating apparatus can only store in its battery device and cannot directly transmit to a power station or power distribution system. Hence, there is a need for improving such a mobile structure of the power generating apparatus.

As is described in greater detail below, the present invention intends to provide a wave energy power generating apparatus. To simplify the entire structure, the wave energy power generating apparatus includes a gearing mechanism provided with a pair of rack assemblies and a pair of one-way gears. The rack assemblies and one-way gears can rotate a transmission shaft in a single predetermined direction. To avoid any inconsistent movement, a single slide shaft is arranged on a fixed base (e.g. seabed) to connect with a buoyant float unit in such a way as to mitigate and overcome the above problem.

### SUMMARY OF THE INVENTION

The primary objective of this invention is to provide a wave energy power generating apparatus, wherein a gearing mechanism is provided with a pair of rack assemblies and a pair of one-way gears. The rack assemblies and one-way gears can rotate a transmission shaft in a single predetermined direction. Accordingly, the entire structure of the wave energy power generating apparatus is simplified.

The secondary objective of this invention is to provide the wave energy power generating apparatus, wherein a single slide shaft is arranged on a fixed base to connect with a buoyant float unit. The single slide shaft permits a completely upward or downward movement of the buoyant float unit with respect to the fixed base. Accordingly, such an arrangement of the single slide shaft can enhance the efficiency of movements of the buoyant float unit.

The wave energy power generating apparatus in accordance with an aspect of the present invention includes a fixed base, a buoyant float unit and at least one gearing mechanism. The fixed base has a slide shaft mounted thereon for connecting with the buoyant float unit. The buoyant float unit includes a buoyant float slidably connected with the slide shaft, and at least one rack mechanism formed with a pair of rack members. The gearing mechanism includes a transmission shaft, and a pair of one-way gears connected with the transmission shaft and engaged with the rack members. The rack members can drive the one-way gears to rotate the transmission shaft in a single predetermined direction when an upward or downward movement of the buoyant float unit occurs.

In a separate aspect of the present invention, a series of the wave energy power generating apparatuses are serially connected by a plurality of adapters and a plurality of connecting shaft.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view illustrating a wave energy power generating apparatus in accordance with a preferred embodiment of the present invention;

FIG. 2 is a top plan view illustrating the wave energy power generating apparatus in accordance with the preferred embodiment of the present invention;

FIG. 3 is a front elevational view illustrating the wave energy power generating apparatus in accordance with the preferred embodiment of the present invention;

FIG. 4 is a side elevational view illustrating operation of the wave energy power generating apparatus in accordance with the preferred embodiment of the present invention;

FIG. 5 is a schematic view illustrating the wave energy power generating apparatus in accordance with the preferred embodiment of the present invention, which is installed on a fixed base; and

FIG. 6 is a top plan view illustrating a series of the connected wave energy power generating apparatuses in accordance with another preferred embodiment of the present invention.

### DETAILED DESCRIPTION OF THE INVENTION

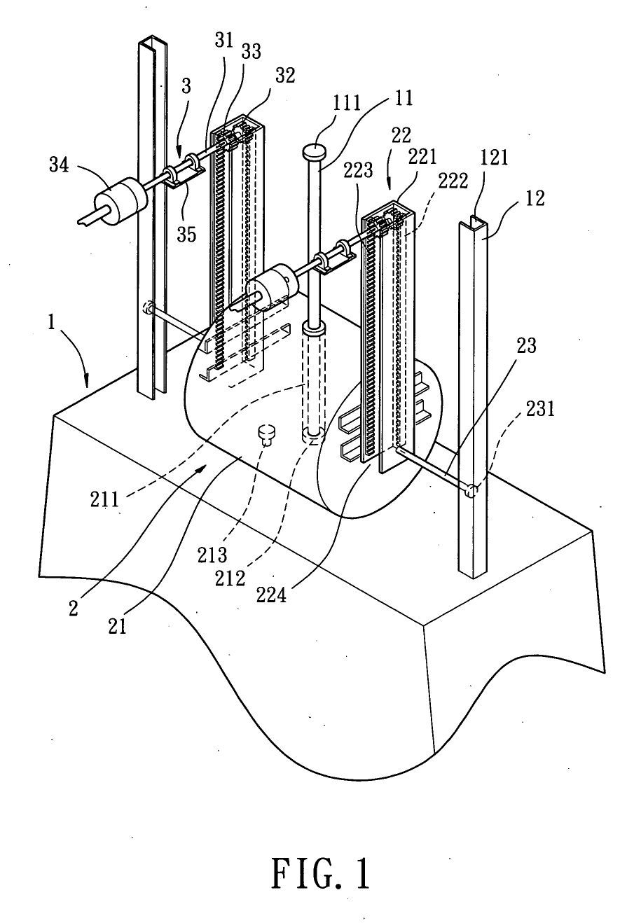

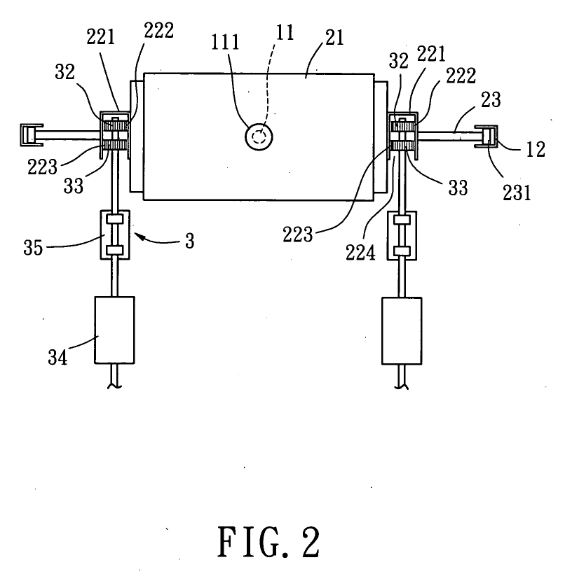

Referring now to FIGS. 1 and 2, perspective and top plan views of a wave energy power generating apparatus in accordance with the preferred embodiment of the present invention are illustrated. In the preferred embodiment, the wave energy power generating apparatus includes a fixed base designated numeral 1, a buoyant float unit designated numeral 2 and at least one gearing mechanism designated numeral 3.

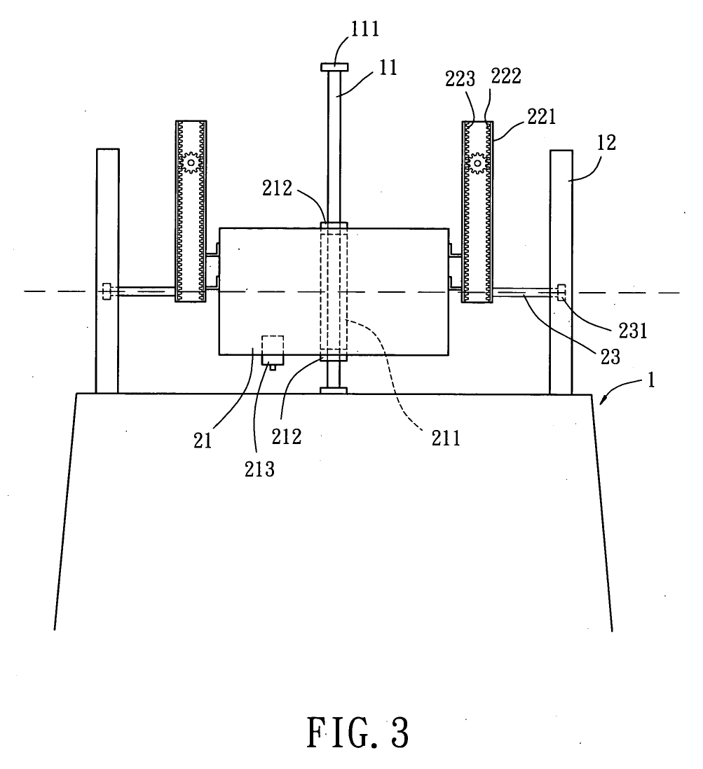

Turning now to FIG. 3, a front elevational view of the wave energy power generating apparatus in accordance with the preferred embodiment of the present invention is illustrated. By referring to FIGS. 1 and 3, construction of the fixed base 1 shall be described in detail. In this preferred embodiment, the fixed base 1 is directly disposed on a seabed (unlabeled) or mounted a post arranged at a seafloor. The fixed base 1 includes a slide shaft 11 and a pair of upright guiding tracks 12 which are vertically extended and exposed on water. In installing operation, the buoyant float unit 2 is supported on the slide shaft 11 and positioned between the upright guiding tracks 12. Preferably, provided on a top end of the slide shaft 11 is a stop member 111 so that an upward movement of the buoyant float unit 2 is limited. In a preferred embodiment, the slide shaft 11 and upright guiding tracks 12 are parallel each other. Each of the upright guiding tracks 12 is formed with a guiding groove 121 which is longitudinally extended. In this preferred embodiment, each opening of the guiding grooves 121 faces a direction toward the slide shaft 11.

With continued reference to FIGS. 1 through 3, construction of the buoyant float unit 2 shall be described in detail. The buoyant float unit 2 includes a buoyant float 21, a pair of rack assemblies 22 and a pair of positioning arms 23. In an alternative embodiment, the buoyant float unit 2 is provided with at least one rack mechanism 22 and at least one positioning arm 23. To receive the slide shaft 11, there is provided a through hole 211 and a pair of bearing members 212 on the buoyant float 21. Preferably, the buoyant float 21 has buoyancy twice as much as a weight itself. The through hole 211 extends through the buoyant float 21 and permits passage of the slide shaft 11. The bearing members 212 are mounted on opposite ends of the through hole 211 to slidably receive the slide shaft 11 such that the slide shaft 11 can reciprocate along the through hole 211. In this manner, the buoyant float 21 can freely move along the slide shaft 11. Preferably, the bearing member 212 may be selected from a linear bearing in such a way as to minimize a frictional force between the bearing member 212 and the slide shaft 11. The buoyant float 21 further includes a valve member 213 arranged at its bottom portion for injecting or discharging water. In this manner, a position of the buoyant float 21 with respect to the surface of water can be adjusted.

In the preferred embodiment, the rack mechanism 22 includes a housing 221, a first rack member 222, a second rack member 223 and a channel 224. The housing 221 is mounted to a distal end of the buoyant float 21, and includes a pair of opposite sidewalls parallel each other. Each of the first rack member 222 and the second rack member 223 are mounted on an inner surface of the sidewall of the housing 221. The first rack member 222 and the second rack member 223 are designed to be in mis-alignment each other. Preferably, delimited between the two sidewalls is the channel 224. Furthermore, the positioning arm 23 is selected from an elongated member having an end on which to rotatably connect a guide wheel 231 to provide for easy guidance of the positioning arm 23. In a preferred embodiment, the positioning arm 23 is extended from the buoyant float 21 or the rack mechanism 22, and received in the guiding grooves 121 of the upright guiding track 12.

Still referring to FIGS. 1 through 3, construction of the gearing mechanism 3 shall be described in detail. In this preferred embodiment, the gearing mechanism 3 includes a transmission shaft 31, a first one-way gear 32, a second one-way gear 33, a gearbox 34 and a bearing seat 35. In assembling operation, the transmission shaft 31 is extended into the channel 224 of the rack mechanism 22. The first one-way gear 32 and the second one-way gear 33 are coaxially arranged on the transmission shaft 31. In this circumstance, the first one-way gear 32 is engaged with the first rack member 222 while the second one-way gear 33 is engaged with the second rack member 223. In a preferred embodiment, the first one-way gear 32 and the second one-way gear 33 are of the same one-way gears each of which can be driven in a predetermined rotational direction; namely, the one-way gear permits an idle rotation in a designated direction. In this preferred embodiment, the idle rotational directions of the first one-way gear 32 and the second one-way gear 33 are opposite such that one of the first one-way gear 32 and the second one-way gear 33 is driven while the other is idle. The transmission shaft 31 mechanically connects with the gearbox 34 which can shift a rotational speed of the transmission shaft 31 properly. Furthermore, the transmission shaft 31 extends through the bearing seat 35 for freely rotational movements. In a preferred embodiment, the bearing seat 35 is mounted on a platform of a power station 4 and the transmission shaft 31 can be mechanically connected with a generating set (not shown).

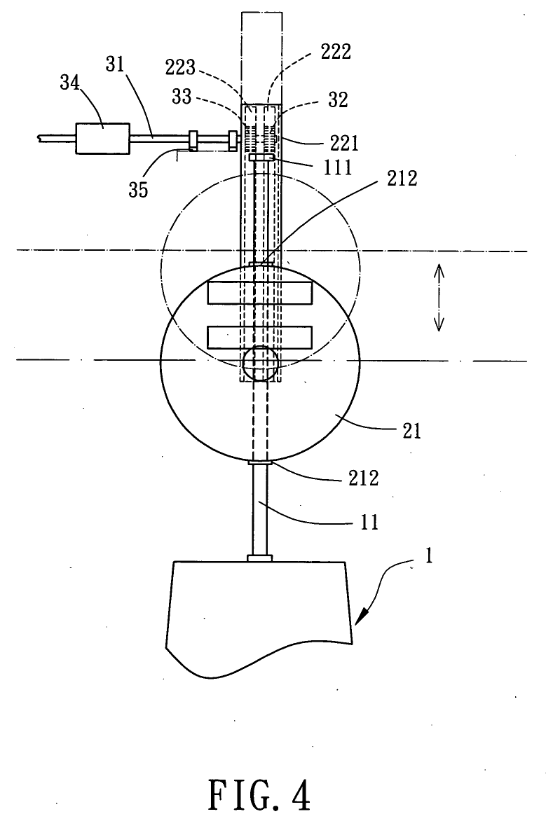

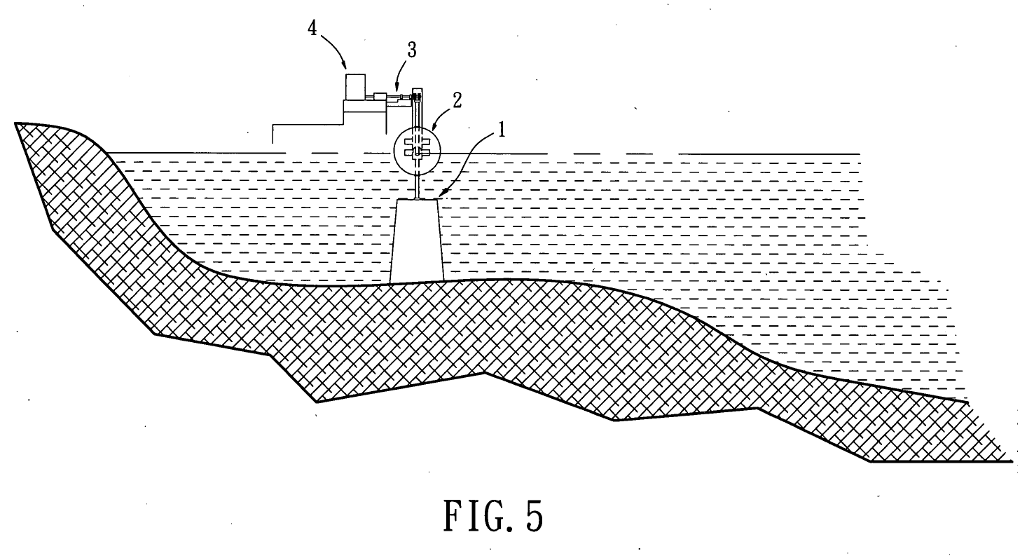

Turning now to FIGS. 4 and 5, a side elevational view of operation of the wave energy power generating apparatus in accordance with the preferred embodiment of the present invention and a schematic view thereof installed on the fixed base are illustrated. By referring to FIGS. 4 and 5, when the wave energy power generating apparatus is installed on the fixed base 1, waves cause upward or downward movements of the buoyant float unit 2 along the slide shaft 11. For example, when the buoyant float 21 is moved upwardly, the first rack member 222 can drive the first one-way gear 32 to rotate the transmission shaft 31 and the second rack member 223 may cause an idle rotation of the second one-way gear 33 about the transmission shaft 31. Conversely, when the buoyant float 21 is moved downward, the second rack member 223 can drive the second one-way gear 33 to rotate the transmission shaft 31 and the first rack member 222 may cause an idle rotation of the first one-way gear 32 about the transmission shaft 31. Consequently, the upward and downward movements of the buoyant float 21 can drive and rotate the transmission shaft 31 in a single predetermined direction. Finally, the rotational movements of the transmission shaft 31 can drive the generating set disposed in the power station 4.

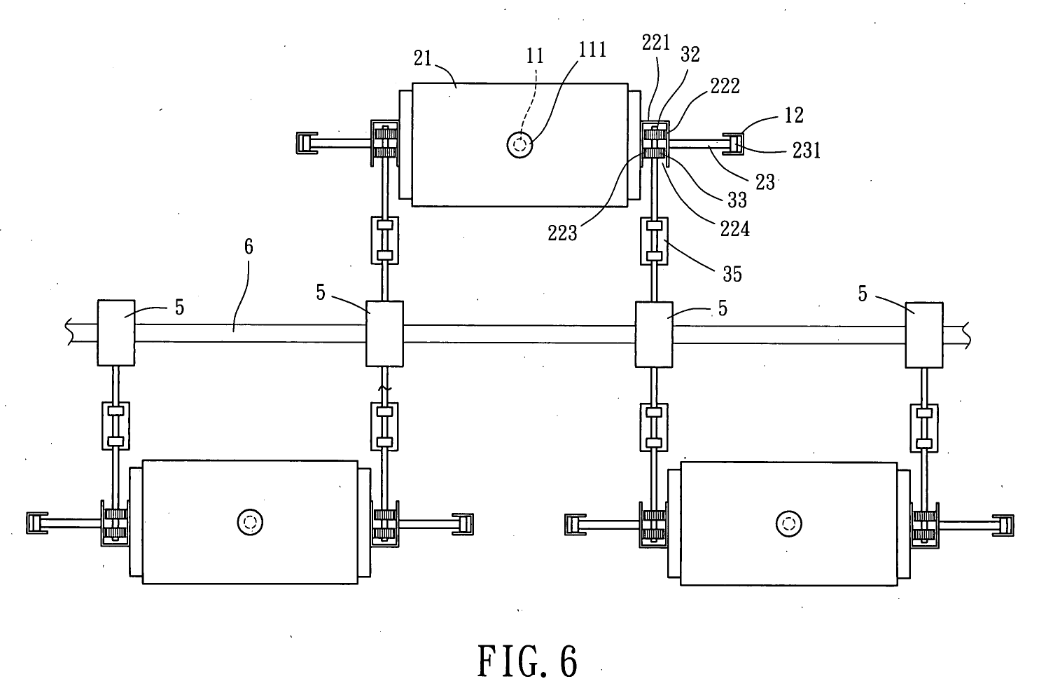

Turning now to FIG. 6, a top plan view of a series of the connected wave energy power generating apparatuses in accordance with another preferred embodiment of the present invention is illustrated. By referring to FIG. 6, a series of the connected wave energy power generating apparatuses is connected by adapters 5 and connecting shafts 6. In this preferred embodiment, the transmission shafts 31 of the wave energy power generating apparatuses mechanically connects with the adapter 5 or the generating set. Advantageously, the connected wave energy power generating apparatuses can enhance the efficiency of power generation.

As has been discussed above, the conventional power generating apparatus has a complicated structure so that there are difficulties in assembly and maintenance. Furthermore, the conventional power generating apparatus cause an inconsistent movement among the slide shafts that affects the movement of the buoyant float unit. Conversely, the wave energy power generating apparatuses in accordance with the present invention includes the rack mechanism 22 and the gearing mechanism 3. Accordingly, the first rack member 222 can directly drive the first one-way gear 32 to rotate the transmission shaft 31 or the second rack member 223 can directly drive the second one-way gear 33 to rotate the transmission shaft 31 in the same rotational direction. Furthermore, the buoyant float unit 2 is mounted on a single member of the slide shaft 11 so as to simplify the entire structure and to avoid inconsistent movements.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A wave energy power generating apparatus comprising:
a slide shaft vertically extended;
a buoyant float unit including a buoyant float and at least one rack mechanism, the buoyant float is supported on the slide shaft, the rack mechanism including a housing provided with a first rack member, a second rack member and a channel, the first rack member and the second rack member being correspondingly mounted on inner surfaces of opposite sidewalls of the housing in mis-alignment each other; and
at least one gearing mechanism including a transmission shaft, a first one-way gear and a second one-way gear, the transmission shaft extended into the channel of the rack mechanism, the first one-way gear being engaged with the first rack member while the second one-way gear being engaged with the second rack member;
wherein when the buoyant float is moved upwardly, the first rack member drives the first one-way gear to rotate the transmission shaft and the second rack member causes an idle rotation of the second one-way gear about the transmission shaft; conversely, when the buoyant float is moved downward, the second rack member drives the second one-way gear to rotate the transmission shaft and the First rack member causes an idle rotation of the first one-way gear about the transmission shaft such that the transmission shaft is successively rotated in a predetermined rotational direction.

2. The wave energy power generating apparatus as defined in claim 1, wherein the buoyant float is provided with a through hole to receive the slide shaft.

3. The wave energy power generating apparatus as defined in claim 2, wherein the buoyant float includes a pair of bearing members which are mounted on opposite ends of the through hole to slidably receive the slide shaft.

4. The wave energy power generating apparatus as defined in claim 1, wherein the rack mechanism includes a gearbox mechanically connected with the transmission shaft.

5. The wave energy power generating apparatus as defined in claim 1, wherein the rack mechanism includes a bearing seat such that the transmission shaft extends through the bearing seat for freely rotational movements.

6. The wave energy power generating apparatus as defined in claim 1, further comprising an adapter such that two of the wave energy power generating apparatuses being serially connected.

7. The wave energy power generating apparatus as defined in claim 1, further comprising at least one upright guiding track, a positioning arm of the buoyant float being received in a guiding grooves of the upright guiding track.

8. The wave energy power generating apparatus as defined in claim 1, wherein a stop member is provide on a top end of the slide shaft so that an upward movement of the buoyant float unit is limited.

9. The wave energy power generating apparatus as defined in claim 1, wherein the buoyant float has buoyancy twice as much as a weight thereof.

10. The searching method for a patent database system as defined in claim 1, wherein the slide shaft is mounted on a fixed base.

11. The wave energy power generating apparatus as defined in claim 7, wherein the upright guiding track is mounted on a fixed base.

12. The wave energy power generating apparatus as defined in claim 1, wherein the buoyant float includes a valve member arranged at its bottom portion.
